(19) United States
(12) Patent Application Publication
(10) Pub. No.: US 2013/0278213 A1
(43) Pub. Date: Oct. 24, 2013

(54) INTEGRATED BATTERY DISPATCHING SYSTEM WITH CENTRALIZED CHARGING AND CENTRALIZED ALLOCATION

(71) Applicants: STATE GRID CORPORATION OF CHINA, Beijing (CN); XU JI GROUP CORPORATION, Xuchang (CN); BEI JING XJ ELECTRIC CO., LTD., Beijing (CN); SOUTHEAST UNIVERSITY, Nanjing (CN)

(72) Inventors: Fei XUE, Beijing (BJ); HongChao LIU, Beijing (BJ); CiWei GAO, Beijing (BJ); Liang ZHANG, Beijing (BJ); Sheng ZHANG, Beijing (BJ); BenHai WEI, Beijing (BJ); Jun SU, Beijing (BJ)

(73) Assignees: STATE GRID CORPORATION OF CHINA, Beijing (CN); SOUTHEAST UNIVERSITY, Nanjing (CN); BEI JING XJ ELECTRIC CO., LTD., Beijing (CN); XU JI GROUP CORPORATION, Xuchang (CN)

(21) Appl. No.: 13/865,207

(22) Filed: Apr. 18, 2013

(30) Foreign Application Priority Data
Apr. 23, 2012 (CN) 201210120734.4

(51) Int. Cl. B60L 11/18

(52) U.S. Cl. CPC B60L 11/1851
USPC 320/109

(57) ABSTRACT

The present invention provides an integrated battery dispatching system with centralized charging and centralized allocation, which comprises an initial parameter setting module (101), a dispatching selection module (102), a delivery parameter setting module (103), a full battery number acquiring module (104), a logistics fleet delivery strategy submodule (105) and a centralized charging station charging strategy submodule (106). The present invention integrally dispatches centralized battery charging, battery dispatching and logistics vehicle allocation, and arranges the battery to be charged with cheap electric energy according to the battery replacement demand of a delivery station in combination with the capacity constraint for a centralized charging station and the power tariff of a power grid. The four integrated dispatching subsystems involved in the present invention can meet the needs of different users, and the users can select a suitable operation mode according to their own characteristics and practical situations.

### CROSS-REFERENCE TO RELATED APPLICATIONS

This application claims the priority benefit of Chinese application no. 201210120734.4, filed on Apr. 23, 2012. The entirety of the above-mentioned patent application is hereby incorporated by reference herein and made a part of specification.

### BACKGROUND OF THE INVENTION

1. Field of the Invention

The present invention relates to a battery centralized charging strategy, and in particular to an integrated battery dispatching system with centralized charging and centralized allocation.

2. Background of the Invention

The electric vehicle industry has experienced rapid development under a strong support from the government. In contrast, the development of electric vehicles is confronted with the biggest bottleneck with respect of the battery. On one hand, the initial investment cost for buying batteries is to large, which generally makes up a half or more of the body cost of electric vehicles. On the other hand, the time for charging is to long, which is up to half an hour even in a fast charging mode, thus is far from meeting the user's demand, and the fast charging brings large damage to the batteries, which in fact increases the cost of batteries for electric vehicles. If the effect of the distributed and random charging of a large number of electric vehicles on the power grid is further considered, the social cost for using electric vehicles further improves.

### BRIEF SUMMARY OF THE INVENTION

The technical problem to be solved by the present invention is, by centralized allocation of batteries, to realize battery centralized management, centralized charging, solve the problems of low battery utilization rate, short battery lifetime or the like in electric vehicles, solve the high total cost of electric vehicles due to the high cost of batteries, and also remove the adverse effect of the electric vehicle distributed and random charging on the power grid.

In order to solve the above problems, the present invention provides an integrated battery dispatching system with centralized charging and centralized allocation, which comprises:

an initial parameter setting module for receiving a set of initial parameter setting information;

a dispatching selection module for selecting corresponding dispatching subsystems;

a delivery parameter setting module for setting corresponding delivery parameters according to the selected dispatching subsystem;

a full battery number acquiring module for obtaining a full battery number which is required to be delivered for each time Q_{demand}(t) according to the delivery parameter and a battery replacement curve Q(t);

a logistics fleet delivery strategy submodule for obtaining the logistics fleet delivery empty battery number Qₛₜₐₜᵢₒₙ_{_{—}}_{empty}_{_{—}}_{battery} (t) and the required logistics vehicle number nᵣₑₐₗ_{_{—}}_{car}(t) according to the full battery number Q_{demand}(t);

a centralized charging station charging strategy submodule for obtaining the number of batteries charged by the centralized charging station for each time nₛₜₐₜᵢₒₙ_{_{—}}ᵣₑₐₗ(t) according to the logistics fleet delivery empty battery number Qₛₜₐₜᵢₒₙ_{_{—}}_{empty}_{_{—}}_{battery}(t) and the full battery demand number for the next moment Q_{demand}(t+1).

As an example, the parameter setting information comprises: the number of batteries that can be charged simultaneously by the centralized charging station N_{capacity}, the power tariff for charging at each moment p(t), the initial full battery number of the centralized charging station Nₛₜₐₜᵢₒₙ_{_{—}}_{full0}, the initial empty battery number of the centralized charging station Nₛₜₐₜᵢₒₙ_{_{—}}_{empty0}, the initial full battery number of the delivery station N_{delivery}_{_{—}}_{full0}, the initial empty battery number of the delivery station N_{delivery}_{_{—}}_{empty0}, the logistics vehicle number N_{car}_{_{—}}ₐₗₗ, the number of batteries that can be loaded by an individual logistics vehicle n_{car}_{_{—}}_{battery}, the transportation expenses per hour for individual logistics vehicle p_{car}, the charging power for individual battery P_{pack} and the required charging time for individual battery t_{pack}.

As an example, when the dispatching selection module selects a quantitative delivery based integrated dispatching subsystem, the delivery parameter setting value is a delivery quantity setting value nₛₑₜ set by the user;

according to the delivery quantity setting value nₛₑₜ and by superimposing the battery replacement number n_{plusi,j} between two adjacent moments on the battery replacement curve Q(t), the full battery number acquiring module obtains the starting time of logistics fleet for each delivery time and the full battery number which is required to be delivered for each time Q_{demand}(t).

As an example, the delivery quantity set by the user refers to such a value that the logistics fleet will start delivery when the delivery station for which the logistics fleet is responsible has a battery replacement total demand larger than this value, but will stop delivery when the delivery station for which the logistics fleet is responsible has a battery replacement total demand less than this value.

As an example, when the dispatching selection module selects a periodical delivery based integrated dispatching subsystem or a “delivery at daytime and charging at nighttime” integrated dispatching subsystem, the delivery parameter setting value is a delivery starting time set by the user;

according to the delivery starting time and by superimposing the battery replacement number between each delivery starting time n_{plusi,j}, the full battery number acquiring module obtains the number of full batteries which are required to be delivered for each time Q_{demand}(t).

As an example, the initial parameter setting module further comprises a path optimization submodule, for directing improved genetic algorithm of chromosomal crossover and mutation by making the standard deviation

$$\sqrt{{\sum }_{k = 1}^{n} {( {t}_{disk} - {\overline{t}}_{dis} )}^{2} / ( n - 1 )}$$

of the time (t_{disk}, k=1, 2, . . . , n) required for each logistics fleet delivery as small as possible according to the logistics fleet number n set by the user, and for obtaining the number of logistics vehicle that each logistics fleet possesses N_{cark} according to the proportional allocation among the battery replacement demand of a delivery station for which each logistics fleet is responsible (N_{batteryk}, k=1, 2, . . . , n), the regional total battery replacement demand N_{battery}_{_{—}}ₐₗₗ and the existing logistics vehicle number N_{car}_{_{—}}ₐₗₗ.

As an example, the number of logistics vehicles that the k^{th} logistics fleet possesses N_{cark} is (N_{batteryk}N_{car}_{_{—}}ₐₗₗ)/N_{battery}_{_{—}}ₐₗₗ.

As an example, when the logistics fleet number n has a value of 1, the improved genetic algorithm of chromosomal crossover and mutation is directed by minimizing the logistics fleet delivery time t_{dis}.

As an example, when a dispatching selection module selects a multi-agent based integrated dispatching subsystem, the system further comprises a delivery time generation module for generating the optimum delivery starting time of each logistics fleet by using a genetic algorithm,

the delivery parameter setting value is an optimum delivery starting time generated by the delivery time generation module, and

the full battery number acquiring module obtains the number of full batteries which are required to be delivered for each time Q_{demand}(t) according to the optimum delivery starting time and by superimposing the battery replacement number curve between each optimum delivery starting time Q(t).

The integrated battery dispatching system with centralized charging and centralized allocation of the present invention integrally allocates centralized battery charging, battery dispatching and logistics vehicle allocation, and arranges the battery to be charged with cheap electric energy according to the battery replacement demand of a delivery station in combination with the capacity constraint for a centralized charging station and the power tariff of a power grid. Besides, the logistics fleet arranges the delivery strategy according to the full battery number of a centralized charging station, the battery replacement demand of a delivery station, and the logistics fleet capacity. For convenience of battery delivery, the centralized charging station is build at a high voltage primary grid of a ring expressway, so that it is possible to avoid the impact of dispersed charge of electric vehicles on the power distribution network, and to ensure that the batteries are sent to each delivery station in a timely manner, thus ensuring the battery replacement service quality of the delivery station. By integrally dispatching centralized battery charging, battery dispatching and logistics vehicle allocation, it is possible to improve the battery utilization rate by charging the empty batteries which have been sent back so that they are available for the next delivery of battery.

By the centralized battery charging management of electric vehicles, the owners of electric vehicles may not buy batteries, but only pay for management fees, rental fees, or the like, so that the cost of electric vehicles is significantly reduced.

The four integrated dispatching subsystems can meet the needs of different users, and the users can select a suitable operation mode according to their own characteristics and practical situations.

The system has the characteristics of rapid, stable and controllable operation, multiple operation modes, environmental friendliness, energy conservation, high degree of intellectualization, and the like.

### BRIEF DESCRIPTION OF THE DRAWINGS

FIG. 1 is a structural view showing an embodiment of an integrated battery dispatching system with centralized charging and centralized allocation according to the present invention.

### DETAILED DESCRIPTION OF THE INVENTION

In order to illustrate an integrated battery dispatching system with centralized charging and centralized allocation of the present invention, the present invention will be elucidated in further detail hereinafter with reference to the accompanying drawing and the particular embodiments.

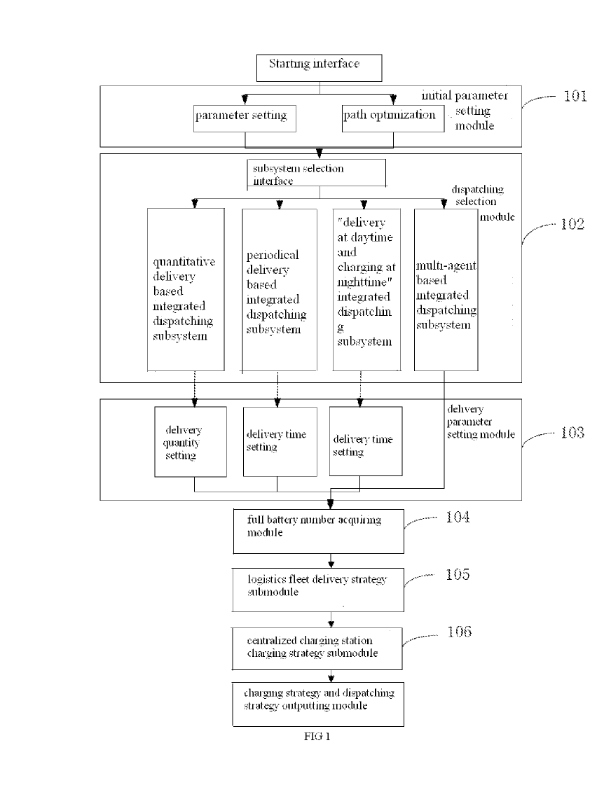

Reference is made to FIG. 1 which is a structural view showing an embodiment of an integrated battery dispatching system with centralized charging and centralized allocation according to the present invention. The system of the present embodiment comprises: an initial parameter setting module 101 for receiving a set of initial parameter setting information; a dispatching selection module 102 for selecting corresponding dispatching subsystems; a delivery parameter setting module 103 for setting corresponding delivery parameters according to the selected dispatching subsystem; a full battery number acquiring module 104 for obtaining a full battery number Q_{demand}(t) which is required to be delivered for each time according to the delivery parameter and a battery replacement curve Q(t); a logistics fleet delivery strategy submodule 105 for obtaining the logistics fleet delivery empty battery number Qₛₜₐₜᵢₒₙ_{_{—}}_{empty}_{_{—}}_{battery}(t) and the required logistics vehicle number nᵣₑₐₗ_{_{—}}_{car}(t) according to the full battery number Q_{demand}(t); and a centralized charging station charging strategy submodule 106 for obtaining the number of batteries charged by the centralized charging station for each time nₛₜₐₜᵢₒₙ_{_{—}}ᵣₑₐₗ(t) according to the logistics fleet delivery empty battery number Qₛₜₐₜᵢₒₙ_{_{—}}_{empty}_{_{—}}_{battery}(t) and the full battery demand number for the next moment Q_{demand}(t+1).

The parameter setting information can comprise: the number of batteries that can be charged simultaneously by the centralized charging station N_{capacity}, the power tariff for charging at each moment p(t), the initial full battery number of the centralized charging station Nₛₜₐₜᵢₒₙ_{_{—}}_{full0}, the initial empty battery number of the centralized charging station Nₛₜₐₜᵢₒₙ_{_{—}}_{empty0}, the initial full battery number of the delivery station N_{delivery}_{_{—}}_{full0}, the initial empty battery number of the delivery station N_{delivery}_{_{—}}_{empty0}, the logistics vehicle number N_{car}_{_{—}}ₐₗₗ, the number of batteries that can be loaded by an individual logistics vehicle n_{car}_{_{—}}_{battery}, the transportation expenses per hour for individual logistics vehicle p_{car}, the charging power for individual battery P_{pack}, the required charging time for individual battery t_{pack}, and logistics fleet number n.

When the dispatching selection module 102 selects a quantitative delivery based integrated dispatching subsystem, the delivery parameter setting value is a delivery quantity setting value nₛₑₜ set by the user. As an example, the delivery quantity set by the user refers to such a value that the logistics fleet will start delivery when the delivery station for which the logistics fleet is responsible has a battery replacement total demand larger than this value, but will stop delivery when the delivery station for which the logistics fleet is responsible has a battery replacement total demand less than this value. According to the delivery quantity setting value nₛₑₜ and by superimposing the battery replacement number n_{plusi,j} between two adjacent moments on the battery replacement curve Q(t), the full battery number acquiring module 104 obtains the starting time of logistics fleet for each delivery time and the full battery number which is required to be delivered for each time Q_{demand}(t). The battery replacement curve Q(t) is a curve for recording battery pack replacement quantity at each moment, in which the horizontal axis stands for time and the vertical axis stands for battery pack replacement quantity. The implementation is set forth as follow. The full battery number acquiring module 104 superimposes on the battery replacement curve Q(t) two moments ti, tj (wherein i=0, and j gradually increases from 0) and the battery replacement number between these two moments. When the superimposed battery replacement number n_{plusi,j} is larger than the set delivery quantity nₛₑₜ, the moment for the first delivery is ti, and the starting time for the next delivery is tj. Then, the calculation for the next delivery time is performed, in which i is set as j (wherein j gradually increases from i), and two moments ti, tj as well as the battery replacement number between these two moments are calculated. When the superimposed battery replacement number n_{plusi,j} is larger than the set delivery quantity nₛₑₜ, the moment for the first delivery is tj. In this manner, the starting time for each delivery can be obtained by superimposing battery replacement curve and according to the set delivery quantity. Further, the full battery number required for each delivery Q_{demand}(t) can be obtained by superimposing battery replacement number between each delivery starting time. By using the full battery number required for each delivery Q_{demand}(t) as an input of the logistics fleet delivery strategy submodule 105, one can obtain the logistics fleet delivery empty battery number Qₛₜₐₜᵢₒₙ_{_{—}}_{empty}_{_{—}}_{battery}(t) and the required logistics vehicle number nᵣₑₐₗ_{_{—}}_{car}(t). The implementation is set forth as follow. If the full battery number required for the delivery station at moment t is Q_{demand}(t), the empty battery number at moment t−1 is Q_{empty}_{_{—}}_{battery}(t−1), and the logistics fleet capacity is C_{logistics}_{_{—}}_{fleet}, the full battery number Q_{supply}(t) that the logistics fleet transport from the centralized charging station to the delivery station is the minimum value among the delivery station battery replacement demand Q_{demand}(t), the centralized charging station full battery number Q_{full}_{_{—}}_{battery}(t), and the logistics fleet capacity C_{logistics}_{_{—}}_{fleet}. The number of empty batteries Qₛₜₐₜᵢₒₙ_{_{—}}_{empty}_{_{—}}_{battery}(t−1) that the logistics fleet sends back from the delivery station is the minimum value between the delivery station empty battery number Q_{empty}_{_{—}}_{battery}(t−1) and the logistics fleet capacity C_{logistics}_{_{—}}_{fleet}. According to the same algorithm, one can obtain the logistics fleet delivery empty battery number Qₛₜₐₜᵢₒₙ_{_{—}}_{empty}_{_{—}}_{battery}(t) at the moment t. According to the number of empty batteries Q_{empty}_{_{—}}_{battery}(t) which are replaced in the delivery station in the previous time period, the logistics fleet determines the required logistics vehicle number in this delivery for each logistics fleet, namely the logistics vehicle number required for the delivery nᵣₑₐₗ_{_{—}}_{car}(t)=max{Q_{empty}_{_{—}}_{battery}(t),Q_{demand}(t−1)}/n_{car}_{_{—}}_{battery}. The empty battery number is the maximum between the battery replacement number in the previous time period and the battery replacement demand Q_{demand}(t+1) in the next time period on the battery replacement curve. The logistics fleet will carry away a corresponding amount of full batteries from the centralized charging station according to the battery replacement demand for the next moment in the delivery station. When the full battery number can not meet the battery replacement demand in the delivery station for the next moment, the logistics fleet will carry away the existing full batteries in the centralized charging station, unload the full batteries when passing each delivery station for which it is responsible, and load the empty batteries in the delivery station as many as possible. Once the logistics fleet provides service for all delivery stations for which it is responsible, it returns to the centralized charging station. According to the transportation expenses per hour for individual logistics vehicle p_{car} and the actual logistics vehicle number required for each delivery nᵣₑₐₗ_{_{—}}_{car}(t), one can obtain the total transportation expenses of the logistics fleet C_{car}. The logistics fleet delivery strategy submodule 105 can ensure that the logistics fleet provides full batteries for the delivery station as much as possible and can carry the empty batteries back to the centralized charging station in time.

By applying the logistics fleet delivery empty battery number Qₛₜₐₜᵢₒₙ_{_{—}}_{empty}_{_{—}}_{battery}(t) and the full battery demand number for the next time period Q_{demand}(t+1) as inputs of the centralized charging station charging strategy submodule 106, one can obtain the battery number for charging at the centralized charging station at each moment nₛₜₐₜᵢₒₙ_{_{—}}ᵣₑₐₗ(t). The implementation is set forth as follow. The centralized charging station should also satisfy the constraints during charging arrangement: the sum of number for batteries being charged prior to the moment t−1 (including moment t−1,

$$t \geq 1 ) {\sum }_{t} {n}_{station \_ real} ( t - 1 )$$

should not be larger than the sum of empty battery number

$${\sum }_{t} {Q}_{station \_ empty \_ battery} ( t - 1 )$$

prior to the moment t−1 (including moment t−1) in the centralized charging station; the sum of number for batteries being charged prior to the moment t−1 (including moment t−1, t≧1) should not be less than the sum of number for full batteries carried from the centralized charging station by each logistics fleet

$${\sum }_{t} {Q}_{full \_ battery} ( t )$$

prior to the moment t (including moment t); the quantity of battery packs being charged at each time period at the centralized charging station nₛₜₐₜᵢₒₙ_{_{—}}ᵣₑₐₗ(t) should not be larger than the number of batteries that can be charged by the centralized charging station at the same time N_{capacity}. The strategy for the centralized charging station to arrange charging is to give priority to arrange charging of empty batteries at a time period with the lowest power tariff under the premise of the above constraints. According to the strategy, if no charging spot is available for charging empty batteries at this time period, the empty batteries will be charged at a time period with the second lowest power tariff, until all empty batteries have been charged. The centralized charging station charging strategy submodule 106 can ensure that the centralized charging station provides full batteries for the delivery station as many as possible. In addition, the number of batteries charged at each moment nₛₜₐₜᵢₒₙ_{_{—}}ᵣₑₐₗ(t) is obtained according to the power tariff p(t) at each moment t as well as the charging power required for charging individual battery P_{pack}, so that the sum of charging fees

$${\sum }_{t} {n}_{station \_ real} ( t ) {P}_{pack} tp ( t )$$

at the centralized charging station at each moment is minimized.

A complete delivery process for the logistics fleet comprises: the logistics fleet loads full batteries from the centralized charging station, then unloads the full batteries at the delivery station for which it is responsible, and finally returns to the centralized charging station and unloads empty batteries.

The delivery station intends to only provide battery replacement service for electric vehicles, instead of charging service. The battery replacement total demand for several delivery stations in a region is under the control of the centralized charging station. The battery replacement number of the delivery station at each moment can be obtained in advance according to predication based on the historical data.

The centralized charging station can provide full batteries for several delivery stations by centralized charging of batteries. The centralized charging station conduct charging arrangement by considering its charging capacity constraints and the peak-valley-flat power tariff and by utilizing the existing empty batteries and the empty batteries replaced at each delivery station.

As an example, when the dispatching selection module 102 selects a periodical delivery based integrated dispatching subsystem, the delivery parameter setting value is a delivery starting time set by the user; the full battery number acquiring module 104 obtains the number of full batteries which are required to be delivered for each time Q_{demand}(t) according to the delivery starting time and by superimposing the battery replacement number between each delivery starting time n_{plusi,j}. By taking the full battery number required for each delivery [symbol] (t) as an input of the logistics fleet delivery strategy submodule 105, one can obtain the logistics fleet delivery empty battery number Qₛₜₐₜᵢₒₙ_{_{—}}_{empty}_{_{—}}_{battery}(t), and the required logistics vehicle number nᵣₑₐₗ_{_{—}}_{car}(t). By taking the logistics fleet delivery empty battery number Qₛₜₐₜᵢₒₙ_{_{—}}_{empty}_{_{—}}_{battery}(t) and the full battery demand number for the next time period Q_{demand}(t+1) as inputs of the centralized charging station charging strategy submodule 106, one can obtain the number of batteries charged at each moment of the centralized charging station nₛₜₐₜᵢₒₙ_{_{—}}ᵣₑₐₗ(t). The implementation is identical to the above mentioned and is not described here for simplicity.

As an example, when the dispatching selection module 102 selects a “delivery at daytime and charging at nighttime” integrated dispatching subsystem, the delivery parameter setting value is a delivery starting time set by the user. In this case, the delivery starting time is the daytime starting time for each delivery. The full battery number acquiring module 104 obtains the number of full batteries which are required to be delivered for each time Q_{demand}(t) according to the daytime starting time for each delivery and by superimposing the daytime battery replacement number between each delivery starting time n_{plusi,j}. By taking the full battery number required for each delivery Q_{demand}(t) as an input of the logistics fleet delivery strategy submodule 105, one can obtain the logistics fleet delivery empty battery number Qₛₜₐₜᵢₒₙ_{_{—}}_{empty}_{_{—}}_{battery}(t) and the required logistics vehicle number nᵣₑₐₗ_{_{—}}_{car}(t). Then, by accumulating the number of empty batteries delivered back at each time

$${\sum }_{t} {Q}_{station \_ empty \_ battery} ( t )$$

and according to the battery replacement total demand at each delivery station in the next day Q_{demand}_{_{—}}_{nextday}, one can know that the number batteries required to be charged at nighttime is

$$min \{ {\sum }_{t} {Q}_{station \_ empty \_ battery} ( t ) , {Q}_{demand \_ nextday} \} .$$

Then the empty batteries are charged at time periods with the lowest power tariff at nighttime, and, if no charging spot is available for charging empty batteries, at time periods with the second lowest power tariff, until all empty batteries have been charged. In this manner, the centralized charging station charging strategy submodule can obtain the number of batteries charged at the centralized charging station at each moment at nighttime nₛₜₐₜᵢₒₙ_{_{—}}ᵣₑₐₗ(t).

As an example, the initial parameter setting module further comprises a path optimization submodule, for directing improved genetic algorithm of chromosomal crossover and mutation by making the standard deviation

$$\sqrt{{\sum }_{k = 1}^{n} {( {t}_{disk} - {\overline{t}}_{dis} )}^{2} / ( n - 1 )}$$

of the time (t_{disk}, k=1, 2, . . . , n) required for each logistics fleet delivery as small as possible according to the logistics fleet number n set by the user (i.e., by applying the serial number of the delivery stations to the integer coding of chromosome, so as to directly enable each delivery station to be provided service by the logistics fleet, and directly forming an initial delivery patch according to the logistics fleet number during encoding), and for obtaining the number of logistics vehicle that each logistics fleet possesses N_{cark} according to the proportional allocation among the battery replacement demand of a delivery station for which each logistics fleet is responsible (N_{batteryk}, k=1, 2, . . . , n), the regional total battery replacement demand N_{battery}_{_{—}}ₐₗₗ and the existing logistics vehicle number N_{car}_{_{—}}ₐₗₗ. For example, the number of logistics vehicles that the k^{th} logistics fleet possesses N_{cark} is (N_{batteryk}N_{car}_{_{—}}ₐₗₗ)/N_{battery}_{_{—}}ₐₗₗ. As an example, when the logistics fleet number n has a value of 1, the improved genetic algorithm of chromosomal crossover and mutation is directed by minimizing the logistics fleet delivery time t_{dis}.

The users can set the logistics fleet number by its own and then optimizes the delivery station for which each logistics fleet is responsible by using the path optimization submodule. Also, the serial number can use the system default logistics fleet number and the serial number of the delivery station for which each logistics fleet is responsible for, wherein the default value is generated randomly by the system according to the logistics vehicle number and the delivery station number.

As an example, when the dispatching selection module selects a multi-agent based integrated dispatching subsystem, the system further comprises a delivery time generation module which primarily generates the optimum delivery starting time for each logistics fleet by using a genetic algorithm. The implementation is set forth as follow. Firstly, the length of chromosome is determined according to the number of half hour in the investigation period, and by such an encoding, the delivery occurs at the whole or half hours Secondly, the chromosomes are encoded into 0 or 1, wherein 0 indicates no delivery and 1 indicates delivery. During encoding of chromosome, it is required that the time interval between two “1” should not be shorter than the time required for an individual delivery. As a result, an initial population is formed by the same method. The delivery time represented by each chromosome in this initial population is the delivery starting time for each logistics fleet. However, this delivery starting time is merely the feasible delivery starting time, but not the optimum delivery starting time. It is required to perform selection, crossover and mutation operation in order to obtain the optimum delivery starting time. The process for the selection, crossover and mutation operation includes the steps of 1) selecting two chromosomes in the population; 2) performing crossover operation on the selected two chromosomes, and if the new chromosome does not satisfy the time interval between neighboring deliveries, re-generates a chromosome which satisfies the delivery time interval; 3) selecting any one bit in one chromosome of the population for operation, i.e., turning it from 1 to 0, or from 0 to 1, and if the new chromosome does not satisfy the time interval between neighboring deliveries, re-generates a chromosome which satisfies the delivery time interval. The index for directing the genetic operation process (i.e., for judging whether the chromosome is acceptable) is based on the minimization of the sum of the logistics transportation expenses C_{car} and the charging fees

$${\sum }_{t} {n}_{station \_ real} ( t ) {P}_{pack} tp ( t )$$

resulting from the delivery starting time represented by the chromosome. The particular operation process for obtaining the index for judging whether the chromosome is acceptable comprises: 1) from the coding of the chromosome, obtaining the delivery starting time the coding of the chromosome represents; 2) obtaining the full battery demand number which is required to be delivered for each time Q_{demand}(t) from the battery replacement number between the neighboring two delivery times superimposed on the delivery curve; 3) obtaining the logistics fleet delivery empty battery number Qₛₜₐₜᵢₒₙ_{_{—}}_{empty}_{_{—}}_{battery}(t) and the required logistics vehicle number nᵣₑₐₗ_{_{—}}_{car}(t) by taking the full battery number required for each delivery Q_{demand}(t) as in input of the logistics fleet delivery strategy submodule 105. The implementation is set forth as follow. In case that the full battery number required at the delivery station at the moment t is Q_{demand}(t), the empty battery number at the moment t−1 is Q_{empty}_{_{—}}_{battery}(t−1), and the logistics fleet capacity is C_{logistics}_{_{—}}_{fleet}, then the full battery number Q_{supply}(t) that the logistics fleet transport from the centralized charging station to the delivery station is the minimum value among the delivery station battery replacement demand Q_{demand}(t), the centralized charging station full battery number Q_{full}_{_{—}}_{battery}(t), and the logistics fleet capacity C_{logistics}_{_{—}}_{fleet}. The number of empty batteries Qₛₜₐₜᵢₒₙ_{_{—}}_{empty}_{_{—}}_{battery}(t−1) that the logistics fleet sends back from the delivery station is the minimum value between the delivery station empty battery number Q_{empty}_{_{—}}_{battery}(t−1) and the logistics fleet capacity C_{logistics}_{_{—}}_{fleet}. According to the same algorithm, one can obtain the logistics fleet delivery empty battery number Qₛₜₐₜᵢₒₙ_{_{—}}_{empty}_{_{—}}_{battery}(t) at the moment t. According to the number of empty batteries Q_{empty}_{_{—}}_{battery}(t) which are replaced in the delivery station in the previous time period, the logistics fleet determines the required logistics vehicle number in this delivery for each logistics fleet, namely the logistics vehicle number required for the delivery nᵣₑₐₗ_{_{—}}_{car}(t)=max{Q_{empty}_{_{—}}_{battery}(t),Q_{demand}(t+1)}/n_{car}_{_{—}}_{battery}. The empty battery number is the maximum between the battery replacement number in the previous time period and the battery replacement demand Q_{demand}(t+1) in the next time period on the battery replacement curve. The logistics fleet will carry away a corresponding amount of full batteries from the centralized charging station according to the battery replacement demand for the next moment in the delivery station. When the full battery number can not meet the battery replacement demand in the delivery station for the next moment, the logistics fleet will carry away the existing full batteries in the centralized charging station, unload the full batteries when passing each delivery station for which it is responsible, and load the empty batteries in the delivery station as many as possible. Once the logistics fleet provides service for all delivery stations for which it is responsible, it returns to the centralized charging station. According to the transportation expenses per hour for individual logistics vehicle p_{car} and the actual logistics vehicle number required for each delivery nᵣₑₐₗ_{_{—}}_{car}(t) one can obtain the total transportation expenses of the logistics fleet C_{car}; 4) by taking the logistics fleet delivery empty battery number Qₛₜₐₜᵢₒₙ_{_{—}}_{empty}_{_{—}}_{battery}(t) and the full battery demand number for the next time period Q_{demand}(t+1) as inputs of the centralized charging station charging strategy submodule 106, obtaining the battery number for charging at the centralized charging station at each moment nₛₜₐₜᵢₒₙ_{_{—}}ᵣₑₐₗ(t). The implementation is set forth as follow. The centralized charging station should satisfy the following constraints during charging arrangement: the sum of number for batteries being charged prior to the moment t−1 (including moment t−1,

$$t \geq 1 ) {\sum }_{t} {n}_{station \_ real} ( t - 1 )$$

should not be larger than the sum of empty battery number

$${\sum }_{t} {Q}_{station \_ empty \_ battery} ( t - 1 )$$

prior to the moment t−1 (including moment t−1) in the centralized charging station; the sum of number for batteries being charged prior to the moment t−1 (including moment t−1, t≧1) should not be less than the sum of number for full batteries carried from the centralized charging station by each logistics fleet

$${\sum }_{t} {Q}_{fully \_ battery} ( t )$$

prior to the moment t (including moment t); the quantity of battery packs being charged at each time period at the centralized charging station nₛₜₐₜᵢₒₙ_{_{—}}ᵣₑₐₗ(t) should not be larger than the number of batteries that can be charged by the centralized charging station at the same time N_{capacity}. The strategy for the centralized charging station to arrange charging is to give priority to arrange charging of empty batteries at a time period with the lowest power tariff under the premise of the above constraints. According to the strategy, if no charging spot is available for charging empty batteries at this time period, the empty batteries will be charged at a time period with the second lowest power tariff, until all empty batteries have been charged. The centralized charging station charging strategy submodule 106 can ensure that the centralized charging station provides full batteries for the delivery station as many as possible. In addition, the number of batteries charged at each moment nₛₜₐₜᵢₒₙ_{_{—}}ᵣₑₐₗ(t) is obtained according to the power tariff p(t) at each moment t as well as the charging power required for charging individual battery P_{pack}, so that the sum of charging fees

$${\sum }_{t} {n}_{station \_ real} ( t ) {P}_{pack} tp ( t )$$

at the centralized charging station at each moment is minimized; 5) by adding the resulting logistics transportation expenses C_{car} in 3) and the resulting charging fees

$${\sum }_{t} {n}_{station \_ real} ( t ) {P}_{pack} tp ( t )$$

in 4). Finally, after selection, crossover and mutation operation of a certain number of generations, the chromosome resulting in the minimum total fees is selected, and the delivery time represented by this chromosome is the optimum delivery time derived from this module. The logistics fleet delivery strategy and centralized charging strategy derived from the optimum delivery starting time are the optimum strategies.

The integrated battery dispatching system with centralized charging and centralized allocation provided by the present invention has been described above in detail. Although the principles and implementations of the present invention have been illustrated with specific examples, this illustration only intends to help understanding of the method and the core idea of the present invention. Meanwhile, it is apparent for the ordinary skilled in the art to modify the particular embodiments and the range of application according to the concept of the present invention. In a word, the description of the present invention should not be construed as limitation to the present invention.

What is claimed is:

1. An integrated battery dispatching system with centralized charging and centralized allocation, characterized in that the system comprises:
an initial parameter setting module for receiving a set of initial parameter setting information;
a dispatching selection module for selecting corresponding dispatching subsystems;
a delivery parameter setting module for setting corresponding delivery parameters according to the selected dispatching subsystem;
a full battery number acquiring module for obtaining a full battery number which is required to be delivered for each time Q_{demand}(t) according to the delivery parameter and a battery replacement curve Q(t);
a logistics fleet delivery strategy submodule for obtaining the logistics fleet delivery empty battery number Qₛₜₐₜᵢₒₙ_{_{—}}_{empty}_{_{—}}_{battery}(t) and the required logistics vehicle number nᵣₑₐₗ_{_{—}}_{car}(t) according to the full battery number Q_{demand}(t); and
a centralized charging station charging strategy submodule for obtaining the number of batteries charged by the centralized charging station for each time nₛₜₐₜᵢₒₙ_{_{—}}ᵣₑₐₗ(t) according to the logistics fleet delivery empty battery number Qₛₜₐₜᵢₒₙ_{_{—}}_{empty}_{_{—}}_{battery}(t), and the full battery demand number for the next moment Q_{demand}(t+1).

2. The system according to claim 1, characterized in that the parameter setting information comprises: the number of batteries that can be charged simultaneously by the centralized charging station N_{capacity}, the power tariff for charging at each moment p(t), the initial full battery number of the centralized charging station Nₛₜₐₜᵢₒₙ_{_{—}}_{full0}, the initial empty battery number of the centralized charging station Nₛₜₐₜᵢₒₙ_{_{—}}_{empty0}, the initial full battery number of the delivery station N_{delivery}_{_{—}}_{full0}, the initial empty battery number of the delivery station N_{delivery}_{_{—}}_{empty0}, the logistics vehicle number N_{car}_{_{—}}ₐₗₗ, the number of batteries that can be loaded by an individual logistics vehicle n_{car}_{_{—}}_{battery}, the transportation expenses per hour for individual logistics vehicle p_{car}, the charging power for individual battery P_{pack}, and the required charging time for individual battery t_{pack}.

3. The system according to claim 2, characterized in that when the dispatching selection module selects a quantitative delivery based integrated dispatching subsystem, the delivery parameter setting value is a delivery quantity setting value nₛₑₜ set by the user;
according to the delivery quantity setting value nₛₑₜ and by superimposing the battery replacement number n_{plusi,j} between two adjacent moments on the battery replacement curve Q(t), the full battery number acquiring module obtains the starting time of logistics fleet for each delivery time and the full battery number which is required to be delivered for each time Q_{demand}(t).

4. The system according to claim 3, characterized in that the delivery quantity set by the user refers to such a value that the logistics fleet will start delivery when the delivery station for which the logistics fleet is responsible has a battery replacement total demand larger than this value, but will stop delivery when the delivery station for which the logistics fleet is responsible has a battery replacement total demand less than this value.

5. The system according to claim 3, characterized in that when the dispatching selection module selects a periodical delivery based integrated dispatching subsystem or a “delivery at daytime and charging at nighttime” integrated dispatching subsystem, the delivery parameter setting value is a delivery starting time set by the user;
according to the delivery starting time and by superimposing the battery replacement number between each delivery starting time n_{plusi,j}, the full battery number acquiring module obtains the number of full batteries which are required to be delivered for each time Q_{demand}(t).

6. The system according to claim 5, characterized in that the initial parameter setting module further comprises a path optimization submodule, for directing improved genetic algorithm of chromosomal crossover and mutation by making the standard deviation
$$\sqrt{{\sum }_{k = 1}^{n} {( {t}_{disk} - {\overline{t}}_{dis} )}^{2} / ( n - 1 )}$$
of the time (t_{disk}, k=1, 2, . . . , n) required for each logistics fleet delivery as small as possible according to the logistics fleet number n set by the user, and for obtaining the number of logistics vehicle that each logistics fleet possesses N_{cark} according to the proportional allocation among the battery replacement demand of a delivery station for which each logistics fleet is responsible (N_{batteryk}, k=1, 2, . . . , n), the regional total battery replacement demand N_{battery}_{_{—}}ₐₗₗ and the existing logistics vehicle number N_{car}_{_{—}}ₐₗₗ.

7. The system according to claim 6, characterized in that the number of logistics vehicles that the k^{th} logistics fleet possesses N_{cark} is (N_{batteryk}N_{car}_{_{—}}ₐₗₗ)/N_{battery}_{_{—}}ₐₗₗ.

8. The system according to claim 7, characterized in that when the logistics fleet number n has a value of 1, the improved genetic algorithm of chromosomal crossover and mutation is directed by minimizing the logistics fleet delivery time t_{dis}.

9. The system according to claim 6, characterized in that when a dispatching selection module selects a multi-agent based integrated dispatching subsystem, the system further comprises a delivery time generation module for generating the optimum delivery starting time of each logistics fleet by using a genetic algorithm,
the delivery parameter setting value is an optimum delivery starting time generated by the delivery time generation module, and
the full battery number acquiring module obtains the number of full batteries which are required to be delivered for each time Q_{demand}(t) according to the optimum delivery starting time and by superimposing the battery replacement number curve between each optimum delivery starting time Q(t).
